(19) United States
(12) Patent Application Publication
(10) Pub. No.: US 2011/0078173 A1
(43) Pub. Date: Mar. 31, 2011

(54) Social Network User Interface

(75) Inventors: Doree Duncan Seligmann, New York, NY (US); Ajita John Singh, Holmdel, NJ (US); Shreeharsh Kelkar, Summit, NJ (US); Adithya Renduchintala, Boulder, CO (US)

(73) Assignee: AVAYA INC., Basking Ridge, NJ (US)

(21) Appl. No.: 12/570,618

(22) Filed: Sep. 30, 2009

(51) Int. Cl. G06F 17/30; G06F 3/048

(52) U.S. Cl. 707/769; 715/764; 707/E17.014

(57) ABSTRACT

A method to easily, quickly and visually identify experts, relevant tags, information associated with the experts, important topics, and emerging trends without some of the disadvantages of the prior art is disclosed. The present invention provides a novel user interface that connects general queries, users, tags, and information sources together.

### CROSS REFERENCE TO RELATED APPLICATIONS

This application is related to U.S. patent application Ser. No. ______ entitled “Method for Determining Communicative Value,” (Attorney Docket: 630-387us) filed on the same date as this application, which is incorporated by reference.

If there are any contradictions or inconsistencies in language between this application and the cases that have been incorporated by reference that might affect the interpretation of the claims in this case, the claims in this case should be interpreted to be consistent with the language in this case.

### FIELD OF THE INVENTION

The present invention relates to telecommunications in general, and, more particularly, to social networks.

### BACKGROUND OF THE INVENTION

Information overload has become a fact of life. The rate of new information being produced is increasing exponentially, and with inexpensive data storage, individuals and enterprises are now able to archive every e-mail, every telephone call, and every communication that occurs. The Internet provides every person with a printing press.

The problem at its core is: How do we deal with all this information? How do I find the relevant information in a sea of noise?

One methodology used in the prior art to sift through information was to go to experts. Experts can be hard to find. Often individuals and enterprises rely on proxies to find experts. These proxies can be in the form of university education (i.e.: person X has a doctorate in the field), a newspaper or magazine (i.e.: if person Y is a columnist writing about the field in the newspaper, then they are probably an expert in that field), etc.

There are several problems with these methods. One is that authorship is a limited form of expertise. Another is that they fail to identify experts in emerging trends or new fields and fail to account for the latest data. Another important problem is that they require reliance on subjective decisions made by university faculties and newspaper editors that are not accountable. These methods also fail to identify experts within an individual enterprise.

Another methodology in the prior art is to use an aggregation of links. Asking: Who is linking to whom on the Internet? Looking at who gets the most links and from whom the links originate is a more objective method of determining the value of an information source, but it too has its problems. One problem is that it is often too general. Often, these systems devolve into glorified online popularity contests. Popular sites link to other popular sites, and valuable information is ignored. Because of this, general information sources tend to rise above those of niche experts. These general information sources are often sources such as newspapers, and so the problems are not solved.

These methods also fail to take into account user ratings. User ratings are relevant to determining the value of information, and may differ for the same user in different areas of expertise.

Social networks now provide a new opportunity to sift through information. In many of the social network services, such as “Twitter” and “Delicious” allow users to add tags to information and to associate those tags with particular users.

For the purpose of this specification, the term “tag” is defined as a non-hierarchical keyword or term assigned to a piece of information, for example and without limitation, a digital file, an internet bookmark, digital image, video, etc.

Information may be tagged in various ways. These ways include, for example and without limitation, users may assign tags, the creator(s) of the information may tag the information upon creation, tags may be assigned by a system automatically as a result of the users participating in a conference, based on word spotting, based on the time the information is produced or accessed, past user activity, etc.

Tracking tags often allows for trends to emerge. When particular tags are used frequently on social networks, those tags are used to identify trends. Visually, this can be done with the use of a “tag cloud.”

For the purpose of this specification, the term “tag cloud” is defined as a visual depiction of tags. In a tag cloud, the tags are often listed alphabetically, and the importance of a tag is shown with font size or color. For example and without limitation, the more popular a tag, the larger it appears in a tag cloud. Thus both finding a tag by alphabet and by popularity is possible. The tags are usually hyperlinks that lead to a collection of items that are associated with a tag. An example of a tag cloud is FIG. 9.

Tag clouds are useful as they provide a quick, visual picture of emerging trends, but they fail to identify experts in those trends. They also fail to identify the accuracy of the tag applied to particular information.

### SUMMARY OF THE INVENTION

The present invention provides a method to easily, quickly and visually identify experts, relevant tags, information associated with the experts, important topics, and emerging trends without some of the disadvantages of the prior art. The present invention provides a novel user interface that connects general queries, users, tags, and information sources together.

In accordance with the illustrative embodiment of the present invention, the social network view, shown in FIG. 2 through FIG. 8, shows a series of icons. These icons correspond to sources of information. Sources of information include, for example and without limitation, text, audio, or video conversations, World Wide Web sites, documents, pictures, photographs, slides, or any information that can be expressed in digital form and all metadata that can be applied to the sources of information. These sources of information may be produced, for example and without limitation, by users, by the system, as a result of conversations between users, etc.

A user may enter a query, in the form of typing it in, or clicking on a user or a tag, and icons may appear, disappear, or move in response to a query. Multiple queries then reveal connections between users, tags, and information in the form of lines. For example and without limitation, in FIG. 8, there is information shown (in social network view 202) in the form of a text conversation, that connects to user Alice, user Dan, the tag “Database,” and the query “Metadata” (entered in query box 201). Then the information is displayed in viewer 205.

This visualization allows users to see the relationship between information, users, and tags. Experts and relevant topics are demonstrated by the relationship between the various icons, lines, and distance.

### BRIEF DESCRIPTION OF THE DRAWINGS

FIG. 1 depicts a schematic diagram of a portion of telecommunications system 100 in accordance with the illustrative embodiment of the present invention.

FIG. 2 depicts a schematic diagram of a portion of telecommunications terminal display 200 in accordance with the illustrative embodiment of the present invention.

FIG. 3 depicts a schematic diagram of a portion of telecommunications terminal display 200 in accordance with the illustrative embodiment of the present invention.

FIG. 4 depicts a schematic diagram of a portion of telecommunications terminal display 200 in accordance with the illustrative embodiment of the present invention.

FIG. 5 depicts a schematic diagram of a portion of telecommunications terminal display 200 in accordance with the illustrative embodiment of the present invention.

FIG. 6 depicts a schematic diagram of a portion of telecommunications terminal display 200 in accordance with the illustrative embodiment of the present invention.

FIG. 7 depicts a schematic diagram of a portion of telecommunications terminal display 200 in accordance with the illustrative embodiment of the present invention.

FIG. 8 depicts a schematic diagram of a portion of telecommunications terminal display 200 in accordance with the illustrative embodiment of the present invention.

FIG. 9 depicts a tag list and a tag cloud in accordance with the illustrative embodiment of the present invention.

FIG. 10 depicts a flowchart of the salient tasks associated with the operation of the illustrative embodiment of the present invention.

FIG. 11 depicts a flowchart of the salient tasks associated with the operation of task 904 in accordance with the illustrative embodiment of the present invention.

FIG. 12 depicts a flowchart of the salient tasks associated with the operation of task 908 in accordance with the illustrative embodiment of the present invention.

FIG. 13 depicts a flowchart of the salient tasks associated with the operation of task 909 in accordance with the illustrative embodiment of the present invention.

### DETAILED DESCRIPTION

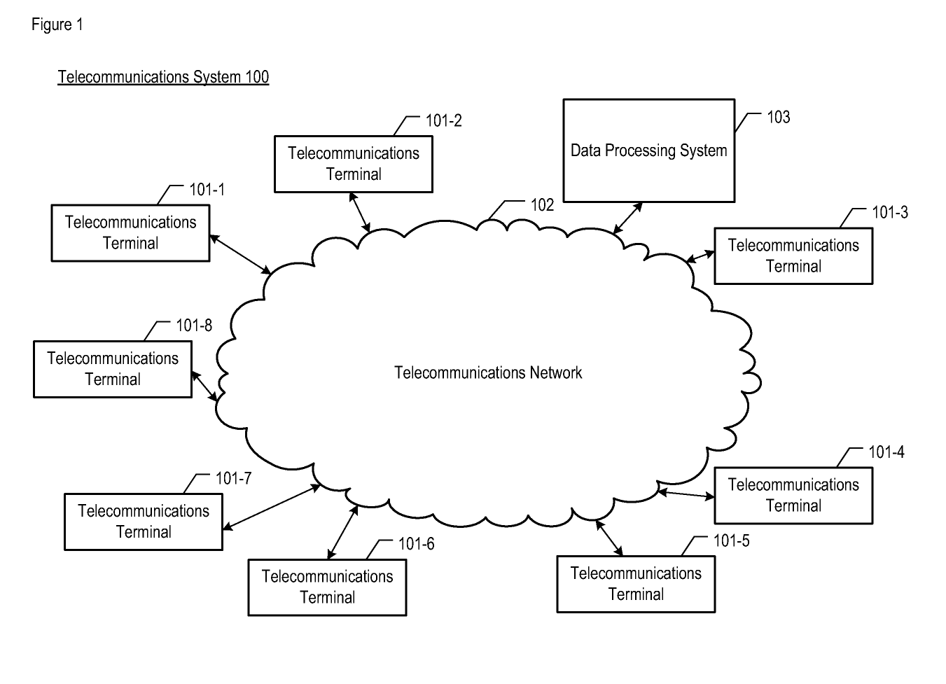

FIG. 1 depicts a schematic diagram of a portion of telecommunications system 100 in accordance with the illustrative embodiment of the present invention. Telecommunications system 100 comprises telecommunications terminals 101-1 through 101-8, telecommunications network 102, and data processing system 103.

Although telecommunications network comprises eight (8) telecommunications terminals, it will be clear to one skilled in the art, after reading this disclosure how to make and use alternative embodiments of the present invention in which there are any number of telecommunications terminals.

Although telecommunications network comprises one telecommunications network, it will be clear to one skilled in the art, after reading this disclosure how to make and use alternative embodiments of the present invention in which there are any number of telecommunications networks.

Although telecommunications network comprises one data processing system, it will be clear to one skilled in the art, after reading this disclosure, how to make and use alternative embodiments of the present invention in which there are any number of data processing systems.

Telecommunications terminals 101-1 through 101-8 are hardware and software for communicating on a telecommunications network. In accordance with the illustrative embodiment of the present invention, telecommunications terminals 101-1, through 101-8 can be either wireline terminals or wireless terminals, or a combination of both. It will be clear to one skilled in the art, after reading this disclosure, how to make and use telecommunications terminals 101-1 through 101-8.

In accordance with the illustrative embodiment of the present invention, telecommunications terminals 101-1 through 101-8 are capable of transmitting, receiving, rendering, and displaying data (including video), but it will be clear to one skilled in the art after reading this disclosure, how to make and use alternative embodiments of the present invention, in which telecommunications terminals 101-1 through 101-8, for example and without limitation, transmit and receive data and video signals without displaying them themselves, only receive data, etc. In accordance with the illustrative embodiment of the present invention, telecommunications terminals 101-1 through 101-8 are devices such as televisions, set-top boxes, personal computers, mobile telecommunications terminals, such as mobile telephones or smartphones, etc.

Telecommunications network 102 is a private network, but it will be clear to those skilled in the art, after reading this disclosure, how to make and use alternative embodiments of the present invention in which telecommunication network 102 is another network, for example and without limitation, the Public Switched Telephone Network, the Internet, a private data network, a community access television network, a cable television system, a fiber optic data network, a satellite network, etc.

Data processing system 103 is hardware and software for distributing data across telecommunications network 102. It will be clear to one skilled in the art, after reading this disclosure, how to make and use data processing system 103.

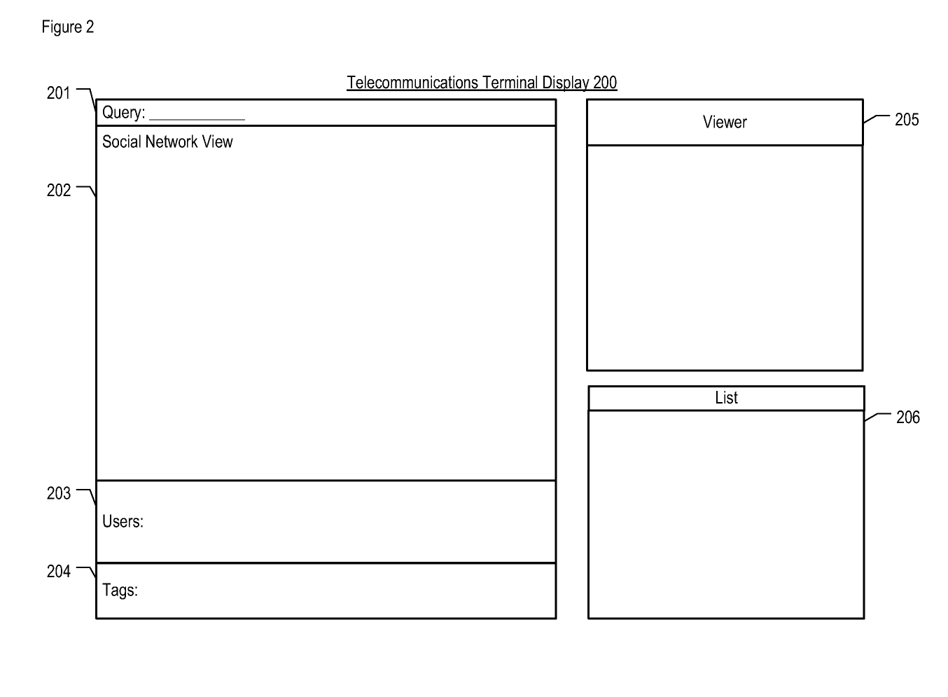

FIG. 2 depicts a schematic diagram of a portion of telecommunications terminal display 200 in accordance with the illustrative embodiment of the present invention. Telecommunications terminal display 200 comprises query box 201, social network view 202, user listing 203, tag listing 204, viewer 205, and list 206.

Although telecommunications terminal display 200 comprises one (1) query box, it will be clear to one skilled in the art, after reading this disclosure how to make and use alternative embodiments of the present invention in which there are any number of query boxes.

Although telecommunications terminal display 200 comprises one (1) social network view, it will be clear to one skilled in the art, after reading this disclosure how to make and use alternative embodiments of the present invention in which there are any number of social network views.

Although telecommunications terminal display 200 comprises one (1) user listing, it will be clear to one skilled in the art, after reading this disclosure how to make and use alternative embodiments of the present invention in which there are any number of user listings.

Although telecommunications terminal display 200 comprises one (1) viewer, it will be clear to one skilled in the art, after reading this disclosure how to make and use alternative embodiments of the present invention in which there are any number of viewers.

Although telecommunications terminal display 200 comprises one (1) list, it will be clear to one skilled in the art, after reading this disclosure how to make and use alternative embodiments of the present invention in which there are any number of lists.

Although telecommunications terminal display 200 displays telecommunications terminal display 200 comprises query box 201, social network view 202, user listing 203, tag listing 204, viewer 205, and list 206 simultaneously, it will be clear to one skilled in the art, after reading this disclosure, how to make and use alternative embodiments of the present invention in which one or more of these elements is omitted from the display.

In accordance with the illustrative embodiment of the present invention, a user enters a first query into query box 201.

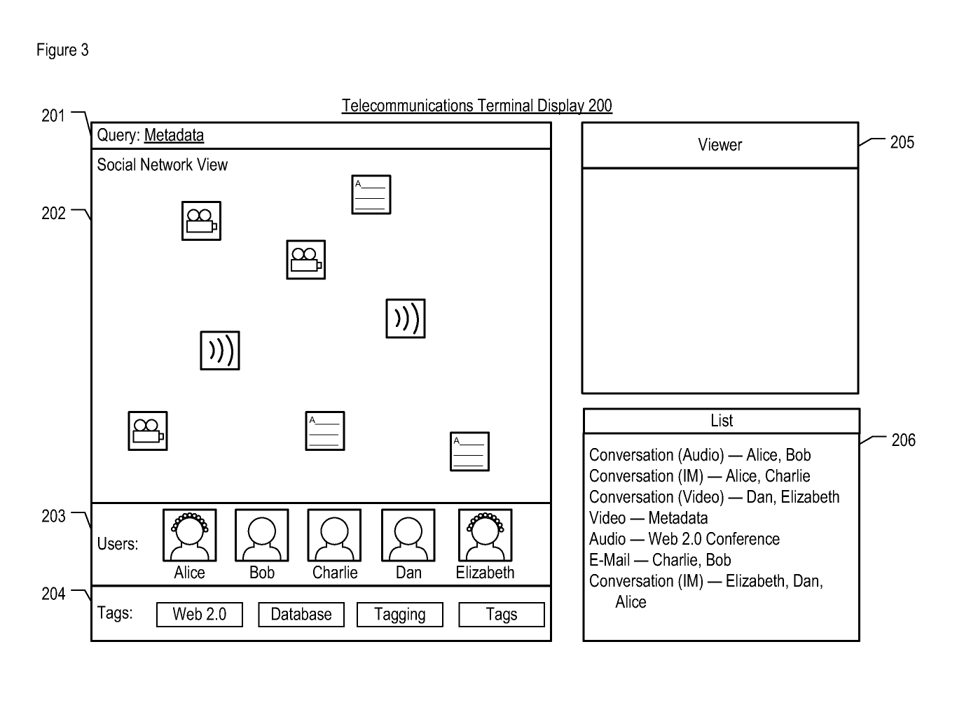

FIG. 3 depicts a schematic diagram of a portion of telecommunications terminal display 200 in accordance with the illustrative embodiment of the present invention. Telecommunications terminal display 200 comprises query box 201, social network view 202, user listing 203, tag listing 204, viewer 205, and list 206.

In accordance with the illustrative embodiment of the present invention, social network view 202, user listing 203, tag listing 204, and list 206 have been populated as a result of a query entered at query box 201.

In accordance with the illustrative embodiment of the present invention, social network view 202 is populated with icons that represent different kinds of information that respond to the query. For example and without limitation these include:
i. audio,
ii. text,
iii. video,
iv. voice, or
v. any combination of i, ii, iii, and iv.
   In any case, it will be clear to those skilled in the art, after reading this disclosure, how to make and use alternative embodiments of the present invention that include social network view 202.

Although social network view 202 comprises eight (8) icons, it will be clear to one skilled in the art, after reading this disclosure how to make and use alternative embodiments of the present invention in which there are any number of icons.

Although social network view 202 is a static picture, in accordance with the illustrative embodiment of the present invention, social network 202 is capable of dynamic representation and the icons in social network view 202 are capable of movement both independently and relative to one another.

Although social network view 202 is a static picture in the figures, in accordance with the illustrative embodiment of the present invention, social network 202 is capable of dynamic representation and additional icons may appear in social network 202 as new information is added to a database. It will be clear to one skilled in the art, after reading this disclosure how to make and use alternative embodiments of the present invention in which social network view 202 does not change, changes periodically, changes immediately when information is added, changes immediately when information is removed, etc.

In accordance with the illustrative embodiment of the present invention, the relative position of the icons is based on their relationship or lack thereof. However, it will be clear to one skilled in the art, after reading this disclosure, how to make and use alternative embodiments of the present invention in which the icons are, for example and without limitation, evenly spaced from one another or positioned in a different manner than the one described.

In accordance with the illustrative embodiment of the present invention, the icons closest to one another have the closest relationship. However, it will be clear to one skilled in the art, after reading this disclosure, how to make and use alternative embodiments of the present invention in which the icons are, for example and without limitation, evenly spaced from one another, do not move closer one another, or move in a different manner than the one described.

In accordance with the illustrative embodiment of the present invention, the icons furthest from to one another have the most distant relationship. However, it will be clear to one skilled in the art, after reading this disclosure, how to make and use alternative embodiments of the present invention in which the icons are, for example and without limitation, evenly spaced from one another, do not move apart, or move in a different manner than the one described.

In accordance with the illustrative embodiment of the present invention, user listing 203 is populated with icons that represent different users and names of the users.

Although user listing 203 comprises five (5) users, it will be clear to one skilled in the art, after reading this disclosure how to make and use alternative embodiments of the present invention in which there are any number of users.

Although user listing 203 comprises both the name and a pictorial representation of users, it will be clear to one skilled in the art, after reading this disclosure how to make and use alternative embodiments of the present invention in which there is any form of representation, for example and without limitation, a text-only representation, a picture-only representation, a list of identifying numbers of users, a list of hyperlinks, etc.

Although user listing 203 comprises both the name and a pictorial representation of users, it will be clear to one skilled in the art, after reading this disclosure how to make and use alternative embodiments of the present invention in which one or more of the text or images are omitted.

Although user listing 203 comprises listings in alphabetical order, it will be clear to one skilled in the art, after reading this disclosure how to make and use alternative embodiments of the present invention in which user listing 203 comprises listings in any order.

Although user listing 203 comprises a list of users that correspond to the first query, it will be clear to one skilled in the art, after reading this disclosure how to make and use alternative embodiments of the present invention in which user listing 203 comprises any list of users, for example and without limitation, all users.

Although user listing 203 is a static picture in the figures, in accordance with the illustrative embodiment of the present invention, user listing 203 is capable of dynamic representation additional and users may appear in user listing 203 as new information is added to a database. It will be clear to one skilled in the art, after reading this disclosure how to make and use alternative embodiments of the present invention in which user listing 203 does not change, changes periodically, changes immediately when information or users are added, changes immediately when information or users are removed, etc.

In accordance with the illustrative embodiment of the present invention, tag listing 204 is populated with icons that represent different tags.

Although tag listing 204 comprises a listing of tags, it will be clear to one skilled in the art, after reading this disclosure how to make and use alternative embodiments of the present invention in which the tags are represented by an alternative means, for example and without limitation, a tag cloud.

Although tag listing 204 does not list the tags in a particular order, it will be clear to one skilled in the art, after reading this disclosure how to make and use alternative embodiments of the present invention in which the tags are listed in an ordering, for example and without limitation, alphabetical order, order of popularity, order or relevance, etc.

Although tag listing 204 comprises four (4) tags, it will be clear to one skilled in the art, after reading this disclosure how to make and use alternative embodiments of the present invention in which there are any number of tags.

In accordance with the illustrative embodiment of the present invention, list 206 is populated with a list of the information that responds to the query.

Although tag listing 204 is a static picture in the figures, in accordance with the illustrative embodiment of the present invention, tag listing 204 is capable of dynamic representation and additional tags may appear in tag listing 204 as new information and tags are added to a database. It will be clear to one skilled in the art, after reading this disclosure how to make and use alternative embodiments of the present invention in which tag listing 204 does not change, changes periodically, changes immediately when information or tags are added, changes immediately when information or tags are removed, etc.

Although list 206 comprises seven (7) listings, it will be clear to one skilled in the art, after reading this disclosure how to make and use alternative embodiments of the present invention in which there are any number of listings.

Although list 206 is a static list in the figures, in accordance with the illustrative embodiment of the present invention, list 206 is capable of dynamic representation and additional items may appear in list 206 as new information is added to a database. It will be clear to one skilled in the art, after reading this disclosure how to make and use alternative embodiments of the present invention in which list 206 does not change, changes periodically, changes immediately when information is added, changes immediately when information is removed, etc.

It will be clear to one skilled in the art, after reading this disclosure, how to make and use alternative embodiments of the present invention in which one or more of social network view 202, user listing 203, tag listing 204, and list 206 are not populated.

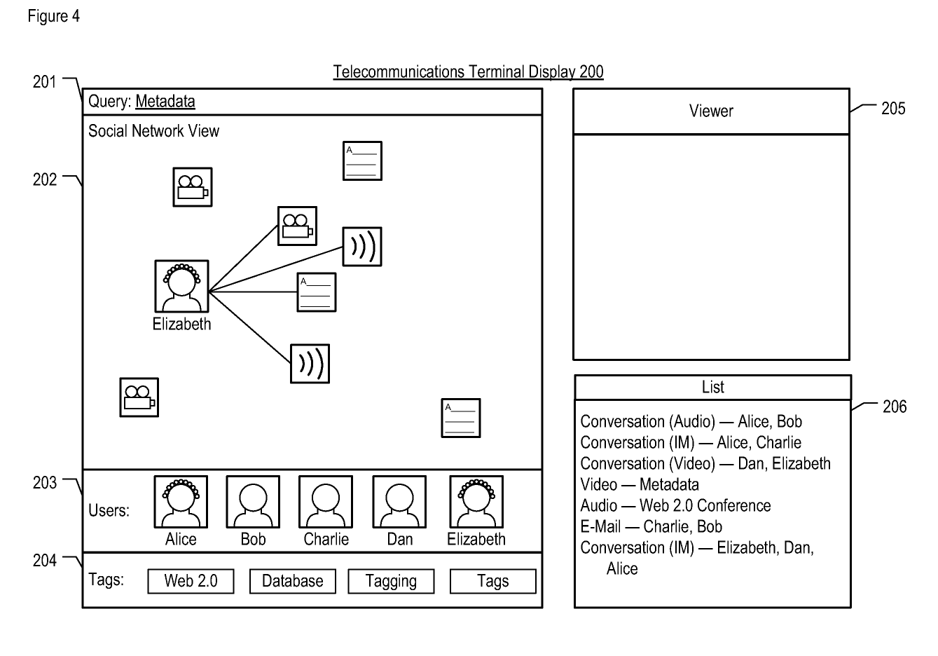

FIG. 4 depicts a schematic diagram of a portion of telecommunications terminal display 200 in accordance with the illustrative embodiment of the present invention. Telecommunications terminal display 200 comprises query box 201, social network view 202, user listing 203, tag listing 204, viewer 205, and list 206.

In accordance with the illustrative embodiment of the present invention, a second query is received. In accordance with the illustrative embodiment of the present invention, this second query may be entered by a user clicking the user “Elizabeth” with a mouse cursor. However, it will be clear to one skilled in the art, after reading this disclosure, how to make and use alternative embodiments of the present invention in which the second query is entered in another manner, for example and without limitation, by typing the user name.

In accordance with the illustrative embodiment of the present invention, the icon representing the user “Elizabeth” is shown in social network view 202.

In accordance with the illustrative embodiment of the present invention, four (4) icons in social network 202, have moved towards the user.

It will be clear to one skilled in the art, after reading this disclosure how to make and use alternative embodiments of the present invention in which any number of icons move towards the user, away from the user, or connect to the user.

In accordance with the illustrative embodiment of the present invention, the icons closest to the user are the ones that are determined to have the closest relationship with the user. However, it will be clear to one skilled in the art, after reading this disclosure, how to make and use alternative embodiments of the present invention in which the icons are, for example and without limitation, evenly spaced from the user, do not move closer to the user, or move in a different manner than the one described.

In accordance with the illustrative embodiment of the present invention, lines connect the four (4) icons in social network 202 that have moved towards the user with the user. This is to represent that the user “Elizabeth” has a relationship with the information represented by the icons.

In accordance with the illustrative embodiment of the present invention, this relationship may include, for example and without limitation:
i. the user has created the information,
ii. the user has tagged the information,
iii. the user has participated in a conversation that is represented by the icon,
iv. the user was mentioned in the information or conversation that is represented by the icon,
v. the user was tagged as relevant to the information by the user, by another user, or by the system itself,
vi. the user is an expert in the field in which the information resides, or
vii. any combination of i, ii, iii, iv, v, and vi.

In accordance with the illustrative embodiment of the present invention, a user may be associated with the information as a whole or the user may be associated with only a portion of the information.

In accordance with the illustrative embodiment of the present invention, four (4) icons in social network 202, have moved away from the user. This is to represent that the user “Elizabeth” does not have a relationship with the information represented by the icons. It will be clear to one skilled in the art, after reading this disclosure, how to make and use alternative embodiments of the present invention in which the icons do not move away or move in a different manner than the one described.

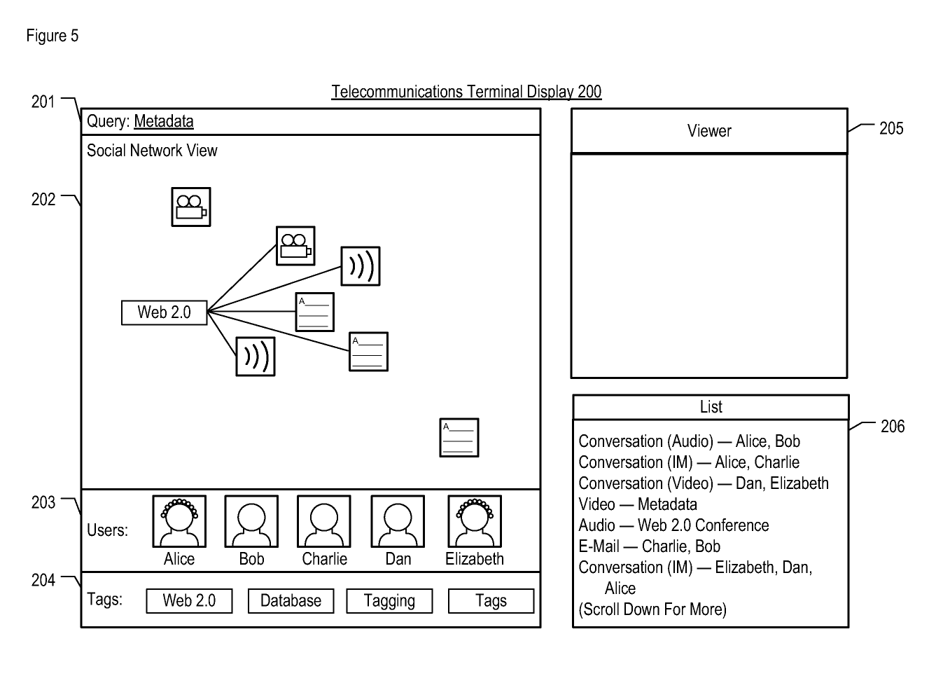

FIG. 5 depicts a schematic diagram of a portion of telecommunications terminal display 200 in accordance with the illustrative embodiment of the present invention. Telecommunications terminal display 200 comprises query box 201, social network view 202, user listing 203, tag listing 204, viewer 205, and list 206.

In accordance with the illustrative embodiment of the present invention, a second query is received. In accordance with the illustrative embodiment of the present invention, this second query may be entered by a user clicking the tag “Web 2.0” with a mouse cursor. However, it will be clear to one skilled in the art, after reading this disclosure, how to make and use alternative embodiments of the present invention in which the second query is entered in another manner, for example and without limitation, by typing the tag.

In accordance with the illustrative embodiment of the present invention, the icon representing the tag, “Web 2.0,” is shown in social network view 202.

In accordance with the illustrative embodiment of the present invention, five (5) icons in social network 202, have moved towards the tag.

In accordance with the illustrative embodiment of the present invention, the icons closest to the tag are the ones that are determined to have the closest relationship with the tag. However, it will be clear to one skilled in the art, after reading this disclosure, how to make and use alternative embodiments of the present invention in which the icons are, for example and without limitation, evenly spaced from the tag, do not move closer to the tag, or move in a different manner than the one described.

In accordance with the illustrative embodiment of the present invention, lines connect the five (5) icons in social network 202 that have moved towards the tag with the tag. This is to represent that the tag “Web 2.0” has a relationship with the information represented by the icons.

In accordance with the illustrative embodiment of the present invention, this relationship may include, for example and without limitation that the tag was applied to the information by a user or another means, that the tag is relevant to the information represented by the icons, etc.

In accordance with the illustrative embodiment of the present invention, a tag may apply to the information as a whole or a tag may be applied to only a portion of the information.

In accordance with the illustrative embodiment of the present invention, two (2) icons in social network 202, have moved away from the user. This is to represent that the tag “Web 2.0” does not have a relationship with the information represented by the icons. It will be clear to one skilled in the art, after reading this disclosure, how to make and use alternative embodiments of the present invention in which the icons do not move away or move in a different manner than the one described.

It will be clear to one skilled in the art, after reading this disclosure how to make and use alternative embodiments of the present invention in which any number of icons move towards the tag, away from the tag, or connect to the tag.

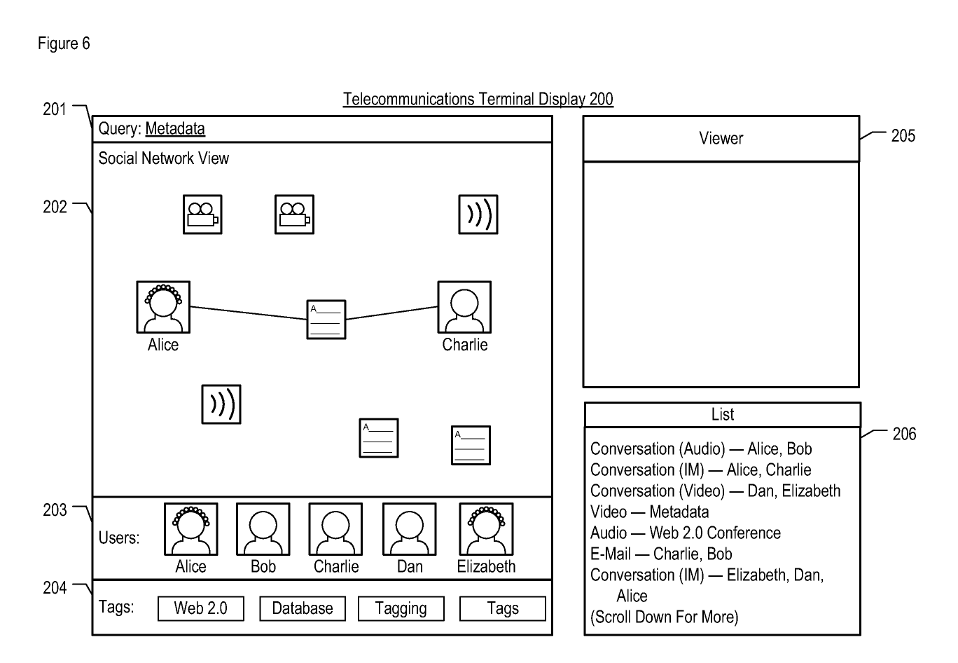

FIG. 6 depicts a schematic diagram of a portion of telecommunications terminal display 200 in accordance with the illustrative embodiment of the present invention. Telecommunications terminal display 200 comprises query box 201, social network view 202, user listing 203, tag listing 204, viewer 205, and list 206.

In accordance with the illustrative embodiment of the present invention, three queries have been received. In accordance with the illustrative embodiment of the present invention, these are the query “Metadata,” the user “Alice,” and the user “Charlie.”

In accordance with the illustrative embodiment of the present invention, the second query may be entered by a user clicking the user “Alice” with a mouse cursor. However, it will be clear to one skilled in the art, after reading this disclosure, how to make and use alternative embodiments of the present invention in which the second query is entered in another manner, for example and without limitation, by typing the user name.

In accordance with the illustrative embodiment of the present invention, the third query may be entered by a user clicking the user “Charlie” with a mouse cursor. However, it will be clear to one skilled in the art, after reading this disclosure, how to make and use alternative embodiments of the present invention in which the third query is entered in another manner, for example and without limitation, by typing the user name.

In accordance with the illustrative embodiment of the present invention, the icon representing the users, Alice and Charlie, are shown in social network view 202.

In accordance with the illustrative embodiment of the present invention, one (1) icon in social network 202, has moved towards the users.

In accordance with the illustrative embodiment of the present invention, a line connects the one (1) icon representing information in social network 202 that has moved towards the users with the users. This is to represent that the user “Alice” and the user “Charlie” together have a relationship with the information represented by the icon.

In accordance with the illustrative embodiment of the present invention, this relationship may include, for example and without limitation:
i. the user(s) have created the information,
ii. the user(s) have tagged the information,
iii. the user(s) have participated in a conversation that is represented by the icon,
iv. the user(s) were mentioned in the information or conversation that is represented by the icon,
v. the user(s) were tagged as relevant to the information by the user, by another user, or by the system itself,
vi. the user(s) are experts in the field in which the information resides, or
vii. any combination of i, ii, iii, iv, v, and vi.

In accordance with the illustrative embodiment of the present invention, six (6) icons in social network 202, have moved away from the users. This is to represent that the users do not have a relationship with the information represented by the icons.

It will be clear to one skilled in the art, after reading this disclosure how to make and use alternative embodiments of the present invention in which any number of icons move towards the users, away from the users, or connect to the users.

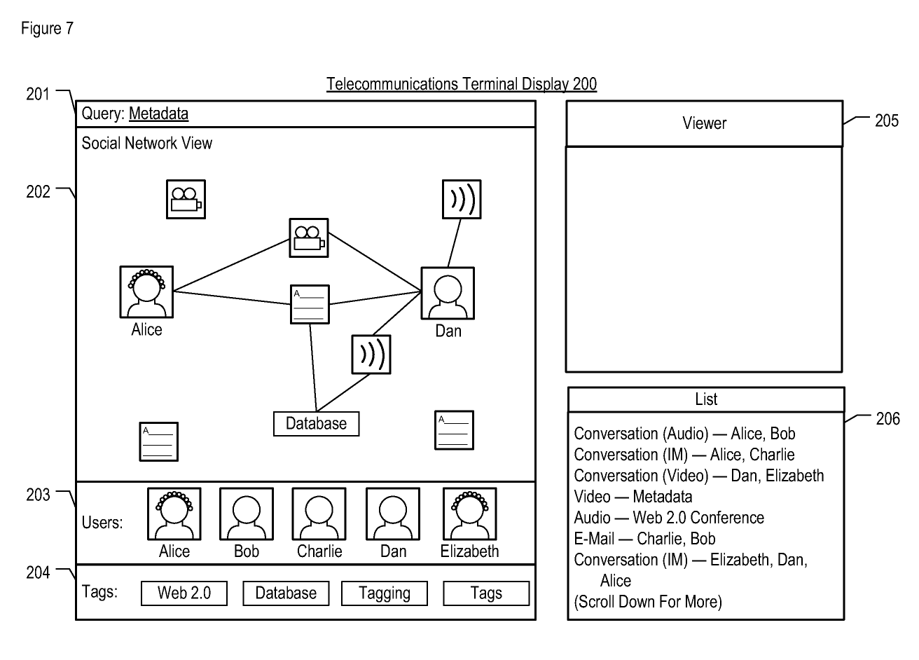

FIG. 7 depicts a schematic diagram of a portion of telecommunications terminal display 200 in accordance with the illustrative embodiment of the present invention. Telecommunications terminal display 200 comprises query box 201, social network view 202, user listing 203, tag listing 204, viewer 205, and list 206.

In accordance with the illustrative embodiment of the present invention, four queries have been received. In accordance with the illustrative embodiment of the present invention, these are the query “Metadata,” the tag “database,” the user “Alice,” and the user “Dan.”

In accordance with the illustrative embodiment of the present invention, the second query may be entered by a user clicking the user “Alice” with a mouse cursor. However, it will be clear to one skilled in the art, after reading this disclosure, how to make and use alternative embodiments of the present invention in which the second query is entered in another manner, for example and without limitation, by typing the user name.

In accordance with the illustrative embodiment of the present invention, the third query may be entered by a user clicking the user “Dan” with a mouse cursor. However, it will be clear to one skilled in the art, after reading this disclosure, how to make and use alternative embodiments of the present invention in which the third query is entered in another manner, for example and without limitation, by typing the user name.

In accordance with the illustrative embodiment of the present invention, the fourth query may be entered by a user clicking the tag “Database” with a mouse cursor. However, it will be clear to one skilled in the art, after reading this disclosure, how to make and use alternative embodiments of the present invention in which the fourth query is entered in another manner, for example and without limitation, by typing the name of the tag.

In accordance with the illustrative embodiment of the present invention, the icon representing the users, “Alice” and “Dan,” are shown in social network view 202.

In accordance with the illustrative embodiment of the present invention, the icon representing the tag, “Database,” is shown in social network view 202.

In accordance with the illustrative embodiment of the present invention, three (3) icons in social network 202, have moved towards the users.

In accordance with the illustrative embodiment of the present invention, a line connects the various icons representing information in social network 202 that have moved towards the users and the tags with the users and the tags. This is to represent the relationships that may exist between the user “Alice,” the user “Dan,” the tag “Database,” and the information represented by the icon. This is also to represent whether the users and tags have a relationship one another.

In accordance with the illustrative embodiment of the present invention, there is a connection with the icon that represents video and “Alice” and “Dan” but not the tag “Database.” This is to represent that the information represented by that particular icon does have a relationship with both “Alice” and “Dan” but not the tag “Database.”

Similarly, a line connects only “Dan” to an icon representing audio because Dan has a relationship with that information, but the user “Alice” and the tag “Database” do not.

Another icon, one representing text, is connected to the user “Alice,” the user “Dan,” and the tag “Database” because that information has a relationship with both users and the tag.

Another icon, one representing audio, is connected to the user “Dan,” and the tag “Database” because that information has a relationship with both users and the tag.

It will be clear to one skilled in the art, after reading this disclosure, how to make and use alternative embodiments of the present invention where there are any number and any type of connections between any user, any tag, and any information.

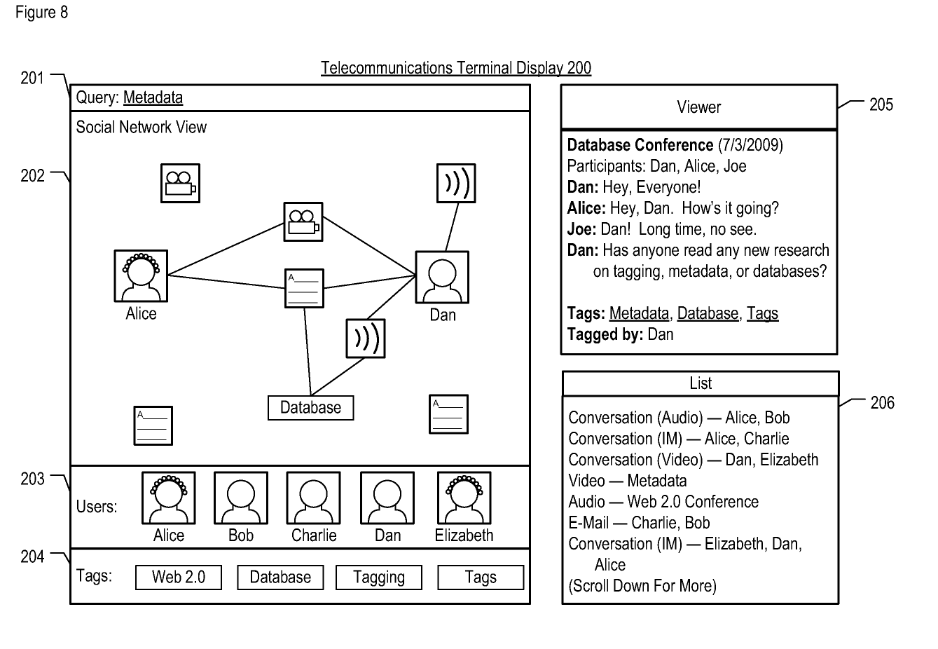

FIG. 8 depicts a schematic diagram of a portion of telecommunications terminal display 200 in accordance with the illustrative embodiment of the present invention. Telecommunications terminal display 200 comprises query box 201, social network view 202, user listing 203, tag listing 204, viewer 205, and list 206.

In accordance with the illustrative embodiment of the present invention, the information represented by a text icon and connected to user “Alice,” user “Dan,” and the tag “Database” is viewed in viewer 205.

In accordance with the illustrative embodiment of the present invention, the information viewed in viewer 205 is a text chat, but it will be clear to one skilled in the art, after reading this disclosure, how to make and use alternative embodiments of the present invention in which the information viewed in viewer 205 is any information. For example and without limitation, this information may include audio, video, other text information, etc. or a combination thereof.

It will be clear to one skilled in the art, after reading this disclosure, how to make and use alternative embodiments of the present invention in which viewer 205 provides a different view, for example and without limitation, a tag cloud view, a history view, etc.

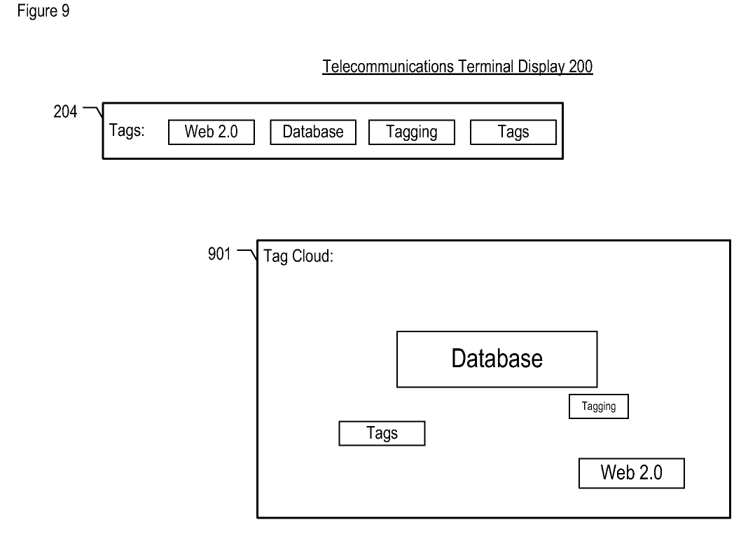

FIG. 9 depicts a tag list and a tag cloud in accordance with the illustrative embodiment of the present invention. FIG. 9 comprises tag listing 204 and tag cloud 901.

Although FIG. 9 comprises one tag listing it will be clear to one skilled in the art, after reading this disclosure how to make and use alternative embodiments of the present invention in which there are any number of tag listings.

Although FIG. 9 comprises one tag cloud it will be clear to one skilled in the art, after reading this disclosure how to make and use alternative embodiments of the present invention in which there are any number of tag clouds.

Although tag listing 204 comprises four (4) tags, it will be clear to one skilled in the art, after reading this disclosure how to make and use alternative embodiments of the present invention in which there are any number of tags.

Although tag listing 204 is a static picture in the figures, in accordance with the illustrative embodiment of the present invention, tag listing 204 is capable of dynamic representation and additional tags may appear in tag listing 204 as new information and tags are added to a database. It will be clear to one skilled in the art, after reading this disclosure how to make and use alternative embodiments of the present invention in which tag listing 204 does not change, changes periodically, changes immediately when information or tags are added, changes immediately when information or tags are removed, etc.

Although tag cloud 901, comprises four (4) tags, it will be clear to one skilled in the art, after reading this disclosure how to make and use alternative embodiments of the present invention in which there are any number of tags.

In accordance with the illustrative embodiment of the present invention, tag cloud 901 has the same tags as in tag listing 204, but they are displayed in a different manner. The tags listed in tag cloud 901 are of different size and different ordering. The tags are listed in descending size order by frequency. That is, the largest tag in tag cloud 901, “Database,” appears most frequently as applied to information. However, it will be clear to one skilled in the art, after reading this disclosure how to make and use alternative embodiments of the present invention in which the ordering is different, for example and without limitation, the tags appear in increasing size by order of frequency, the tags appear in order of rating, the tags appear in descending order by the level of expertise of the user that assigned the tag, etc.

Although tag cloud 901, comprises all the tags in tag listing 204 it will be clear to one skilled in the art, after reading this disclosure, how to make and use alternative embodiments of the present invention in which there are a different number of tags in tag cloud 901 than from tag listing 204, for example and without limitation, tag cloud 901 may only have the most relevant tags listed, tag cloud 901 may have every tag in the database listed, etc.

Although tag cloud 901, comprises the same tags as in tag listing 204 it will be clear to one skilled in the art, after reading this disclosure, how to make and use alternative embodiments of the present invention in which there are a different tags in tag cloud 901 than from tag listing 204.

Also, in accordance with the illustrative embodiment of the present invention, the tags in tag cloud 901 are also in alphabetical order from top to bottom and left to right. That is, the top, left tag in tag cloud 901, “Database,” is comes before the next tag, “Tagging,” in alphabetical order. However, it will be clear to one skilled in the art, after reading this disclosure how to make and use alternative embodiments of the present invention in which the ordering is different, for example and without limitation, the tags appear in the opposite of alphabetical order, that the tags are listed right to left, that the tags are listed bottom to top, etc.

Also, in accordance with the illustrative embodiment of the present invention, the largest tag in tag cloud 901 appears in the middle of tag cloud 901. However, it will be clear to one skilled in the art, after reading this disclosure how to make and use alternative embodiments of the present invention in which the largest tag appears anywhere in tag cloud 901.

Although tag cloud 901 is a static picture in the figures, in accordance with the illustrative embodiment of the present invention, tag cloud 901 is capable of dynamic representation and additional tags may appear in tag cloud 901 as new information and tags are added to a database. It will be clear to one skilled in the art, after reading this disclosure how to make and use alternative embodiments of the present invention in which tag cloud 901 does not change, changes periodically, changes immediately when information or tags are added, changes immediately when information or tags are removed, etc.

It will be clear to one skilled in the art, after reading this disclosure how to make and use alternative embodiments of the present invention in which tag listing 204 is replaced by tag cloud 901, tag listing 204 is supplemented by tag cloud 901, there is some combination of tag listing and tag cloud, or both are omitted.

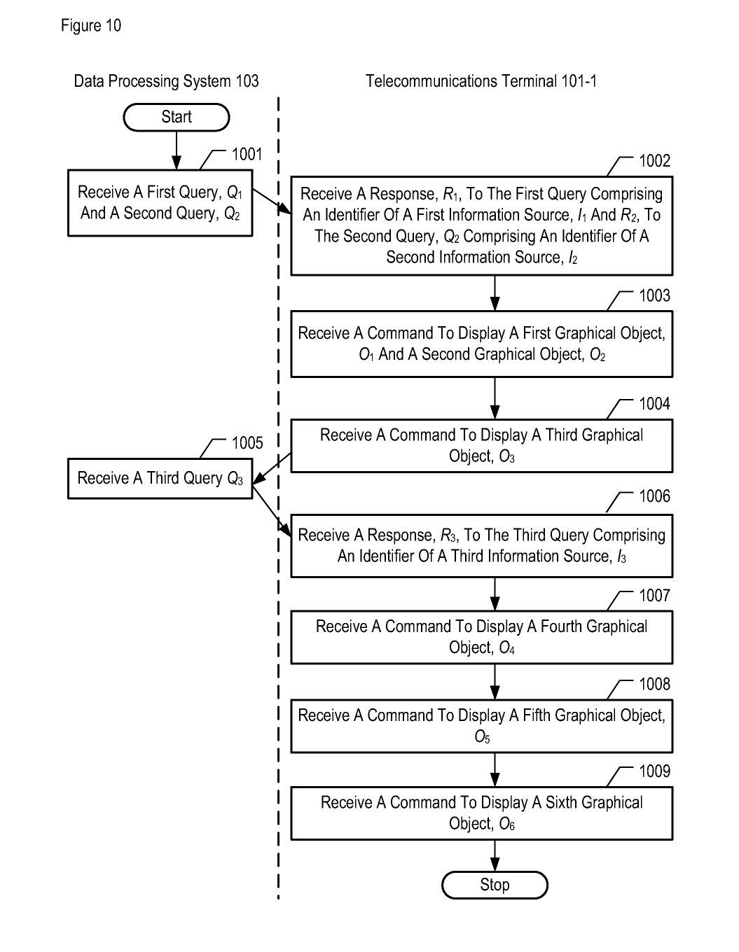

FIG. 10 depicts a flowchart of the salient tasks associated with the operation of the illustrative embodiment of the present invention.

In accordance with the illustrative embodiment of the present invention, the tasks outlined in FIG. 10 are performed at data processing system 103 and telecommunications terminal 101-1. However, it will be clear to one skilled in the art, after reading this disclosure, how to make and use other implementations of the present invention in which some or all of the steps are performed by another device, for example, and without limitation, a different telecommunications terminal, a separate data processing system, a television, a server, etc.

At task 1001, data processing system 103 receives a first query, Q₁, and a second query Q₂ from telecommunications terminal 101-1. In accordance with the illustrative embodiment of the present invention, the first query, Q₁, is the query entered in query box 201 at a telecommunications terminal. It will be clear to one skilled in the art, after reading this disclosure how to make and use alternative embodiments of the present invention in which the first query, Q₁, is entered in a different manner.

In accordance with the illustrative embodiment of the present invention, the second query, Q₂, is the query entered in by a user at a telecommunications terminal by clicking the icon representing a user or a tag. It will be clear to one skilled in the art, after reading this disclosure how to make and use alternative embodiments of the present invention in which the first query, Q₁, is entered in a different manner.

At task 1002, telecommunications terminal 101-1 receives a response, R₁, to the first query comprising an identifier of a first information source, I₁, and a response R₂, to the second query, Q₂ comprising an identifier of a second information source, I₂. It will be clear to one skilled in the art, after reading this disclosure, how to make and use alternative embodiments of the present invention in which the response R₁ and response R₂, comprise any number of information sources. It will be clear to one skilled in the art, after reading this disclosure, how to make and use alternative embodiments of the present invention in which the identifier of the first information source, I₁, and the identifier of the second information source, I₂, are null, for example and without limitation, when there is no information matching first query, Q₁ and/or the second query, Q₂.

At task 1003, telecommunications terminal 101-1 receives a command to display a first graphical object, O₁, and a second graphical object, O₂. Although, in accordance with the illustrative embodiment of the present invention this command originates from data processing system 103, it will be clear to one skilled in the art, after reading this disclosure, how to make and use alternative embodiments of the present invention in which this command is given by telecommunications terminal 101-1 or another system.

In accordance with the illustrative embodiment of the present invention, the first graphical object, O₁, would be an icon in social network view 202. It will be clear to one skilled in the art, after reading this disclosure how to make and use alternative embodiments of the present invention in which the first graphical object, O₁, is a different object, for example and without limitation, a representation of a user, a representation of a tag, or any graphical object.

In accordance with the illustrative embodiment of the present invention, the second graphical object, O₂, would be a representation of a user or a tag in social network view 202. It will be clear to one skilled in the art, after reading this disclosure how to make and use alternative embodiments of the present invention in which the second graphical object, O₂, is a different object, for example and without limitation, an icon or any graphical object.

At task 1004, telecommunications terminal 101-1 receives a command to display a third graphical object, O₃. Although, in accordance with the illustrative embodiment of the present invention this command originates from data processing system 103, it will be clear to one skilled in the art, after reading this disclosure, how to make and use alternative embodiments of the present invention in which this command is given by telecommunications terminal 101-1 or another system. This task is further detailed in FIG. 10.

In accordance with the illustrative embodiment of the present invention, the third graphical object, O₃, would be a line in social network view 202 connecting the first graphical object, O₁, and the second graphical object, O₂, if there is a relationship. It will be clear to one skilled in the art, after reading this disclosure how to make and use alternative embodiments of the present invention in which the third graphical object, O₃, is a different object, for example and without limitation, an icon or any graphical object.

At task 1005, data processing system 103 receives a third query, Q₃, from telecommunications terminal 101-1.

At task 1006, telecommunications terminal 101-1 receives a response, R₃, to the third query comprising an identifier of a third information source, I₃.

At task 1007, telecommunications terminal 101-1 receives a command to display a fourth graphical object, O₄.

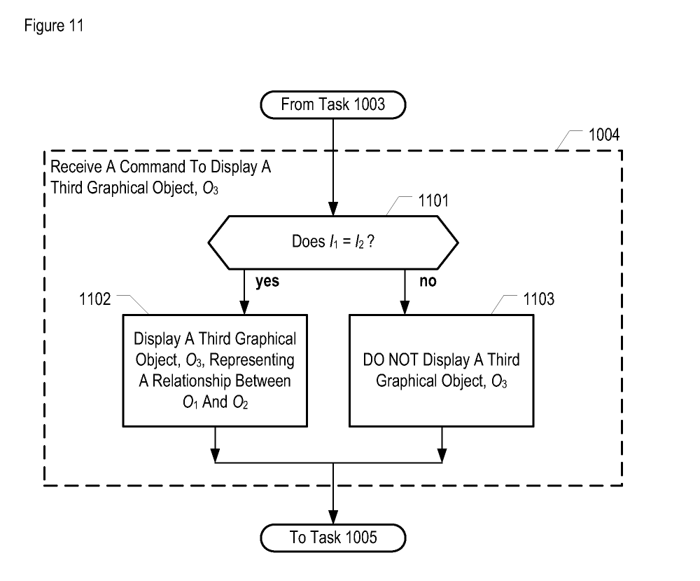

At task 1008, telecommunications terminal 101-1 receives a command to display a fifth graphical object, O₅. Although, in accordance with the illustrative embodiment of the present invention this command originates from data processing system 103, it will be clear to one skilled in the art, after reading this disclosure, how to make and use alternative embodiments of the present invention in which this command is given by telecommunications terminal 101-1 or another system. This task is further detailed in FIG. 11.

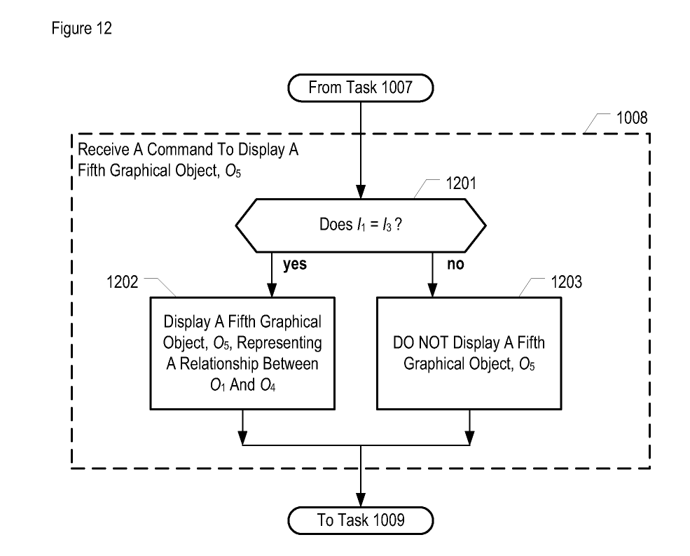

At task 1009, telecommunications terminal 101-1 receives a command to display a sixth graphical object, O₆. Although, in accordance with the illustrative embodiment of the present invention this command originates from data processing system 103, it will be clear to one skilled in the art, after reading this disclosure, how to make and use alternative embodiments of the present invention in which this command is given by telecommunications terminal 101-1 or another system. This task is further detailed in FIG. 12.

It will be clear to one skilled in the art, after reading this disclosure, how to make and use other implementations of the present invention in which one or more of the steps are omitted or are performed in a different order than the one presented or simultaneously.

FIG. 11 depicts a flowchart of the salient tasks associated with the operation of task 1004 in accordance with the illustrative embodiment of the present invention.

At task 1101, telecommunications terminal 101-1 determines whether I₁=I₂. If this does, this indicates a relationship between the information received and the first query and a user or tag. In accordance with the illustrative embodiment of the present invention, if there is such a relationship then it should be displayed.

In accordance with the illustrative embodiment of the present invention, because the third graphical object, O₃, is the line connecting the first graphical object, O₁, and the second graphical object, O₂, this line should only connect when the information source has the relationship represented by a matching of I₁ and I₂. However, it will be clear to one skilled in the art, after reading this disclosure, how to make and use alternative embodiments of the present invention in which the third graphical object, O₃, is drawn as a result of a different relationship.

At task 1102, telecommunications terminal 101-1 displays the relationship.

At task 1103, telecommunications terminal 101-1 DOES NOT display a relationship.

It will be clear to one skilled in the art, after reading this disclosure, how to make and use other implementations of the present invention in which one or more of the steps are omitted or are performed in a different order than the one presented or simultaneously.

FIG. 12 depicts a flowchart of the salient tasks associated with the operation of task 1008 in accordance with the illustrative embodiment of the present invention.

At task 1201, telecommunications terminal 101-1 determines whether I₁=I₃. If this does, this indicates a relationship between the information received and the first query and a user or tag. In accordance with the illustrative embodiment of the present invention, if there is such a relationship then it should be displayed.

In accordance with the illustrative embodiment of the present invention, because the fifth graphical object, O₅, is the line connecting the first graphical object, O₁, and the fourth graphical object, O₄, this line should only connect when the information source has the relationship represented by a matching of I₁ and I₃. However, it will be clear to one skilled in the art, after reading this disclosure, how to make and use alternative embodiments of the present invention in which the fifth graphical object, O₅, is drawn as a result of a different relationship.

At task 1202, telecommunications terminal 101-1 displays the relationship.

At task 1203, telecommunications terminal 101-1 DOES NOT display a relationship.

It will be clear to one skilled in the art, after reading this disclosure, how to make and use other implementations of the present invention in which one or more of the steps are omitted or are performed in a different order than the one presented or simultaneously.

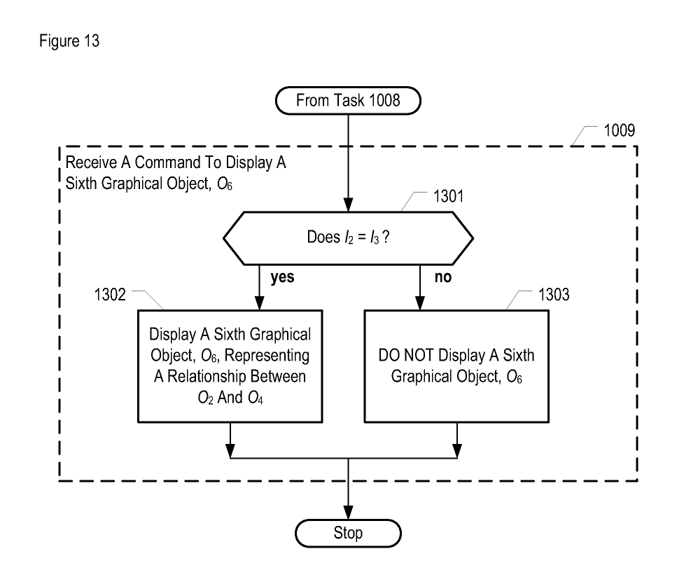

FIG. 13 depicts a flowchart of the salient tasks associated with the operation of task 1009 in accordance with the illustrative embodiment of the present invention.

At task 1301, telecommunications terminal 101-1 determines whether I₁=I₄. In accordance with the illustrative embodiment of the present invention, if there is such a relationship then it should be displayed.

In accordance with the illustrative embodiment of the present invention, because the sixth graphical object, O₆, is the line connecting the second graphical object, O₂, and the fourth graphical object, O₄, this line should only connect when the information source has the relationship represented by a matching of I₂ and I₃. However, it will be clear to one skilled in the art, after reading this disclosure, how to make and use alternative embodiments of the present invention in which the sixth graphical object, O₆, is drawn as a result of a different relationship.

At task 1302, telecommunications terminal 101-1 displays the relationship.

At task 1303, telecommunications terminal 101-1 DOES NOT display a relationship.

It will be clear to one skilled in the art, after reading this disclosure, how to make and use other implementations of the present invention in which one or more of the steps are omitted or are performed in a different order than the one presented or simultaneously.

It is to be understood that the disclosure teaches just one example of the illustrative embodiment and that many variations of the invention can easily be devised by those skilled in the art after reading this disclosure and that the scope of the present invention is to be determined by the following claims.

What is claimed is:

1. A method comprising:
receiving at a data processing system:
(i) a first query, Q₁, and
(ii) a second query, Q₂; and
transmitting from the data processing system:
(iii) a response, R₁, to the first query, Q₁, comprising an identifier of a first information source, I₁,
(iv) a response, R₂, to the second query, Q₂ comprising an identifier of a second information source, I₂,
(v) a command to display a first graphical object, O₁ representing the first information source, I₁, at a telecommunications terminal,
(vi) a command to display a second graphical object, O₂, representing the second information source, I₂, at a telecommunications terminal, and
(vii) a command to display a third graphical object, O₃, representing a relationship between O₁ and O₂, at the telecommunications terminal, when I₁=I₂.

2. The method of claim 1 wherein the second query, Q₂, is to a user.

3. The method of claim 1 wherein the second query, Q₂, is to a tag.

4. The method of claim 1 wherein the first graphical object, O₁, is an icon.

5. The method of claim 1 wherein the second graphical object, O₂, is an icon.

6. The method of claim 1 wherein the third graphical object, O₂, is a line.

7. The method of claim 1 wherein the first query is received from the telecommunications terminal.

8. The method of claim 1 wherein the first query is received from a user.

9. The method of claim 1 further comprising:
transmitting from the data processing system:
(viii) a command to display the first graphical object, O₁, and the first graphical object, O₂, apart from one another when I₁≠I₂.

10. The method of claim 1 further comprising:
receiving at the data processing system:
(viii) a third query, Q₃; and
transmitting from the data processing system:
(ix) a response, R₃, to the third query, Q₃, comprising an identifier of a third information source, I₃,
(x) a command to display a fourth graphical object, O₄, representing the third information source, I₃, at a telecommunications terminal, and
(xi) a command to display fifth graphical object, O₅, representing a relationship between O₁ and O₄, at the telecommunications terminal, when I₁=I₃.

11. The method of claim 10 further comprising:
transmitting from the data processing system:
(xii) a command to display sixth graphical object, O₆, representing a relationship between O₂ and O₄, at the telecommunications terminal, when I₂=I₃.

12. A method comprising:
transmitting from a telecommunications terminal to a data processing system:
(i) a first query, Q₁, and
(ii) a second query, Q₁; and
receiving from the data processing system at the telecommunications terminal:
(iii) a response, R₁, to the first query, Q₁, comprising an identifier of a first information source, I₁,
(iv) a command to display a first graphical object, O₁ representing the first information source, I₁, at a telecommunications terminal,
(v) a response, R₂, to the second query, Q₂ comprising an identifier of a second information source, I₂,
(vi) a command to display a second graphical object, O₂, representing the second information source, I₂, at a telecommunications terminal, and
(vii) a command to display a third graphical object, O₃, representing a relationship between O₁ and O₂, at the telecommunications terminal, when I₁=I₂.

13. The method of claim 12 further comprising displaying at the telecommunications terminal the first graphical object, O₁, the second graphical object, O₂, and the third graphical object, O₃, in response to commands received from the data processing system.

14. The method of claim 12 further comprising:
receiving from the data processing system:
(viii) a command to display the first graphical object, O₁, and the first graphical object, O₂, apart from one another when I₁≠I₂.

15. The method of claim 12 further comprising:
transmitting to the data processing system:
(viii) a third query, Q₃; and
receiving from the data processing system:
(ix) a response, R₃, to the third query, Q₃ comprising an identifier of a third information source, I₃,
(x) a command to display a fourth graphical object, O₄ representing the third information source, I₃, at a telecommunications terminal, and
(xi) a command to display fifth graphical object, O₅, representing a relationship between O₁ and O₄, at the telecommunications terminal, when I₁=I₃.

16. The method of claim 15 further comprising:
receiving from the data processing system:
(xii) a command to display sixth graphical object, O₆, representing a relationship between O₂ and O₄, at the telecommunications terminal, when I₂=I₃.

17. The method of claim 15 further comprising displaying, at the telecommunications terminal, the fourth graphical object, O₄, and the fifth graphical object, O₅, in response to commands received from the data processing system.

18. A method comprising:
displaying at a telecommunications terminal:
(i) a first graphical object, O₁, representing a first information source, I₁, at a telecommunications terminal,
(ii) a second graphical object, O₂, representing a second information source, I₂, at a telecommunications terminal, and
(iii) a third graphical object, O₃, representing a relationship between O₁ and O₂, at the telecommunications terminal, when I₁=I₂,
wherein:
(iv) an identifier of a first information source, I₁, is received in response to a first query, Q₁, and
(iv) an identifier of a second information source, I₂, is received in to a second query, Q₂.

19. The method of claim 18 wherein the first query, Q₁, and the second query, Q₂, are transmitted to a data processing system.

20. The method of claim 18 wherein the response to the first query, Q₁, and the second query, Q₂, are received from a data processing system.

21. The method of claim 18 further comprising displaying first graphical object, O₁, and the first graphical object, O₂, apart from one another when I₁≠I₂.

22. The method of claim 18 further comprising:
displaying:
(iv) a fourth graphical object, O₄, representing a third information source, I₃,
(v) a fifth graphical object, O₅, representing a relationship between O₁ and O₄, at the telecommunications terminal, when I₁=I₃, wherein
wherein:
(vi) an identifier of a third information source, I₃, is received in response to a third query, Q₃.

23. The method of claim 22 further comprising:
displaying:
(vii) a sixth graphical object, O₆, representing a relationship between O₂ and O₄, when I₂=I₃.
